(19) United States
(12) Patent Application Publication
(10) Pub. No.: US 2022/0354119 A1
(43) Pub. Date: Nov. 10, 2022

(54) COMPOSITION OF A RHEOLOGY MODIFIER AND DIHALOHYDANTOIN

(71) Applicant: Rohm and Haas Company, Collegeville, PA (US)

(72) Inventor: Jessica R. Levin, Philadelphia, PA (US)

(73) Assignees: Rohm and Haas Company, Collegeville, PA (US); Rohm and Haas Company, Collegeville, PA (US)

(21) Appl. No.: 17/763,404

(22) PCT Filed: Oct. 6, 2020
(86) PCT No.: PCT/US2020/054380

§ 371 Date: Mar. 24, 2022

Related U.S. Application Data
(60) Provisional application No. 62/916,975, filed on Oct. 18, 2019.

(51) Int. Cl. A01N 43/50; A01N 25/10

(52) U.S. Cl. CPC A01N 43/50; A01N 25/10

(57) ABSTRACT

The present invention relates to an aqueous composition comprising a rheology modifier and 1-bromo-3-chloro-5,5-dimethylhydantoin. The composition is useful for controlling viscosity in a paint formulation and contains a biocide that is efficacious and safe.

### BACKGROUND OF THE INVENTION

The present invention relates to an aqueous composition comprising a rheology modifier and a dihalohydantoin composition, more particularly 1-bromo-3-chloro-5,5-dimethylhydantoin.

The coating industry has aggressively sought to prepare waterborne coatings formulations with close to zero levels of volatile organic compounds (VOCs). An unintended consequence of this pursuit is the greater susceptibility of the formulations to increased microbial growth in the wet state: VOCs, usually relatively low boiling point solvents, confer antimicrobial properties to the formulations; consequently, low or 0 VOC coatings formulations require even higher concentration of added biocide to offset the absence of the VOCs.

The most commonly used wet-state biocides are isothiazolinones which include 2-methyl-4-isothiazolin-3-one (MIT), 5-chloro-2-methyl-4-isothiazolin-3-one (CMIT), and 1,2-benzisothiazol-3-one (BIT), all of which show broad spectrum efficacy and excellent compatibility with materials used in coatings formulations, such as rheology modifiers, as well as the formulations themselves. Unfortunately, isothiazolinones have fallen into disfavor because they have been found to be skin sensitizers. In fact, the rising incidence of allergic reactions attributed to isothiazolinones has led to further regulations, especially in Europe and Canada, restricting the use level of these biocides. Accordingly, it would be advantageous to discover an alternative biocide to replace isothiazolinones, one that retains the advantages of this disfavored class of biocides and that is acceptable from an environmental, health, and safety (EH&S) perspective.

### SUMMARY OF THE INVENTION

The present invention addresses a need in the art by providing a composition comprising water, and, based on the weight of the composition a) from 5 to 50 weight percent of a rheology modifier; and b) from 1 ppm to 1500 ppm 1-bromo-3-chloro-5,5-dimethylhydantoin. The composition of the present invention provides a rheology modifier that is resistant to microbial growth and uses a biocide that would be acceptable from an EH&S perspective.

### DETAILED DESCRIPTION OF THE INVENTION

The present invention is a composition comprising water, and, based on the weight of the composition a) from 5 to 50 weight percent of a rheology modifier; and b) from 1 ppm to 1500 ppm 1-bromo-3-chloro-5,5-dimethylhydantoin.

A rheology modifier (also known as a thickener) is a water compatible material that is used to control the viscosity of a coating composition. Examples of suitable rheology modifiers include a hydrophobically modified alkylene oxide urethane copolymer, preferably a hydrophobically modified ethylene oxide urethane copolymer (HEUR), an alkali swellable emulsion (ASE), a hydrophobically modified alkali swellable emulsion (HASE), a (HEC), or a hydrophobically modified hydroxyethyl cellulose (HMHEC). Preferably the rheology modifier is a HEUR in a concentration in the range of from 5, more preferably from 10 weight percent, to 40, more preferably to 35 weight percent, based on the weight of the composition.

HEURs, which are well-known in the art, are conveniently prepared by contacting under reactive conditions a hydrophobic compound; a polyisocyanate; and a water-soluble polyalkylene glycol. The hydrophobic compound comprises amine groups, alcohol groups, or both and is aliphatic, cycloaliphatic, aryl, or a combination thereof. If the hydrophobic compound comprises both amine groups and alcohol groups, it is preferred that the amine group is a secondary amine, a tertiary amine, or a quaternary ammonium salt. Similarly, if the hydrophobic compound comprises two amine groups, it is preferred that one of the amine groups is a secondary amine, a tertiary amine, or a quaternary ammonium salt.

Examples of suitable hydrophobic compounds include n-hexanol; n-octanol; n-decanol, n-dodecanol; n-hexadecanol; 2-(t-butylamino)ethanol; 2-(dibutylamino)ethanol; 2-(dioctylamino)ethanol; (dioctylamino)ethanol; 2-(diheptylamino)ethanol; 2-(bis(2-ethylhexyl)amino)ethanol; 2-(dihexylamino)ethanol; 3-(dibutylamino)propanol; 2-(dibutylamino)ethylamine; 3-(dibutylamino)propylamine; N-benzyl-N-methylethanolamine; 1-(dibutylamine)-2-butanol; 4-amino-1-benzyl-piperidine; 1-(benzyl(2-hydroxyethyl)amino)-3-alkoxypropan-2-ols such as 1-(benzyl(2-hydroxyethyl)amino)-3-butoxypropan-2-ol and 1-(benzyl(2-hydroxyethyl)amino)-3-(2-ethylhexyl)oxypropan-2-ol; 1-[bis(phenylmethyl)aminol]-3-[(2-alkoxyl-]2-propanols such as 1-[bis(phenylmethyl)amino]-3-[(2-butyl)oxyl]-2-propanol and 1-[bis(phenylmethyl)amino]-3-[(2-ethylhexyl)oxyl]-2-propanol; and dibenzylaminopolyalkylene oxides of the type:

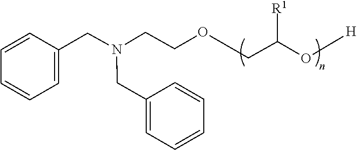

where R¹ is methyl or ethyl and n is from 1 to 10.

Other examples of suitable hydrophobic compounds include compounds of the following structures:

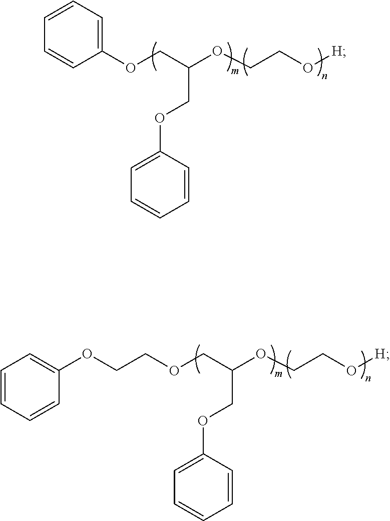

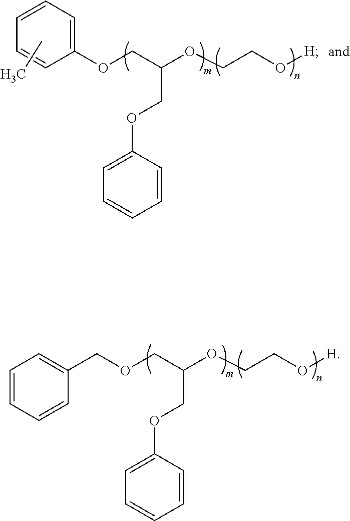

The polyisocyanate starting material is a C₄-C₂₀ aliphatic or aromatic diisocyanate or a tri- or tetraisocyanate branching agent. As used herein, “aliphatic diisocyanate” refers to saturated or partially unsaturated linear-, branched-, or cycloaliphatic diisocyanates, or combinations thereof. Examples of suitable diisocyanates include 1,4-tetramethylene diisocyanate, 1,6-hexamethylene diisocyanate, 2,2,4-trimethyl-1,6-diisocyanatohexane, 1,10-decamethylene diisocyanate, 4,4′-methylenebis(isocyanatocyclohexane), 1,4-cyclohexylene diisocyanate, 1-isocyanato-3-isocyanatomethyl-3,5,5-trimethylcyclohexane, m- and p-phenylene diisocyanate, 2,6- and 2,4-toluene diisocyanate, xylene diisocyanate, 4-chloro-1,3-phenylene diisocyanate, 4,4′-biphenylene diisocyanate, 4,4′-methylene diphenylisocyanate, 1,5-naphthylene diisocyanate, and 1,5-tetrahydronaphthylene diisocyanate. Suitable triisocyanates include isocyanurate trimers and biuret trimers characterized by the following formulas:

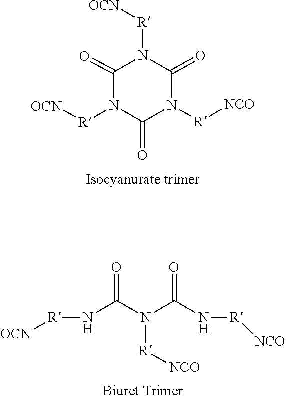

where R′ is a C₄-C₂₀ alkylene group. As used herein, “alkylene group” refers to a biradical saturated or partially saturated hydrocarbyl group that is linear, branched, or cycloaliphatic, or a combination thereof.

Examples of suitable isocyanurate trimers include hexamethylene diisocyanate (HDI) trimer, commercially available as Desmodur N 3600 aliphatic polyisocyanate and isophorone diisocyanate (IPDI) trimer, commercially available as Demodur X 4470 aliphatic polyisocyanate.

A water-soluble polyalkylene glycol refers to water-soluble polyethylene oxides, water-soluble polyethylene oxide/polypropylene oxide copolymers, and water-soluble polyethylene oxide/polybutylene oxide copolymers.

Preferred water-soluble polyalkylene oxides are polyethylene glycols, particularly polyethylene glycols having a weight average molecular weight (M_{w}) in the range of from 4000, more preferably from 6000, and most preferably from 7000 to 20,000, more preferably to 12,000 and most preferably to 9000 Daltons. An example of a suitable polyethylene glycol is PEG 8000, which is commercially available as CARBOWAX™ 8000 Polyethylene Glycol, which is a trademark of The Dow Chemical Company or its affiliates.

The concentration of 1-bromo-3-chloro-5,5-dimethylhydantoin in the composition is preferably in the range of from 5 ppm, more preferably from 10 ppm, to preferably 1000 ppm, more preferably to 500 ppm, and most preferably to 100 ppm, based on the weight of the composition. It may be desirable to add sufficient acid to reduce the HEUR solution pH to ˜4.5 to reduce the concentration of 1-bromo-3-chloro-5,5-dimethylhydantoin needed to achieve a passing result.

It has been surprisingly been discovered that only 1-bromo-3-chloro-5,5-dimethylhydantoin was found to be efficacious and non-degradative of all the environmentally acceptable biocides tested.

The composition of the present invention is useful in a coatings composition, more particular pigmented coatings compositions (paints). Thus, in another aspect the composition further includes a binder, a pigment, and any or all of the following materials: defoamers, surfactants, solvents, extenders, coalescents, and opaque polymers.

### EXAMPLES

A number of biocides were admixed with ACRYSOL™ RM-2020E Rheology Modifier (RM-2020E, A Trademark of The Dow Chemical Company or Its Affiliates) and ACRYSOL™ RM-8W (RM-8W). In addition to testing biocides admixed with RM-2020E or RM-8W as-delivered, acid was also added to the rheology modifiers to lower the pH to approximately 4.5. Samples prepared with the biocide didecyldimethylammonium chloride were only tested when RM-2020E and RM-8W were prepared with 10-15% surfactant in the composition. The compositions were heat-aged in an oven maintained at 50° C. for 2 weeks. Heating aging was also carried out for RM-2020E in the absence of any biocide. If the composition failed the heat aging test, it was not tested for efficacy.

Efficacy of all biocides were determined as described for 1-bromo-3-chloro-5,5-dimethylhydantion. The only difference was the concentration of the biocide, which is shown as a range in Table 1.

1-Bromo-3-chloro-5,5-dimethylhydantoin (0.5% aqueous solution) was prepared by dispersing Chlorox Pool and Spa (0.25 g in 49.75 g water). Unpreserved RM-2020E thickeners were dosed with biocide and challenge tested with bacteria using the TAUNOVATE℠ III High Throughput testing system. In general, the tested biocides were calibrated for density and prepared at levels 10× higher than the target concentrations using a robotic system. For example, to target 15 ppm and 40 ppm concentrations of 1-bromo-3-chloro-5,5-dimethylhydantoin respectively, 150 ppm and 400 ppm concentrations of 1-bromo-3-chloro-5,5-dimethylhydantoin were prepared by the automated system. Then, 60 μL of biocide was added to 540 μL of the unpreserved RM-2020E. The sample blocks were vortexed using a MixMate for 10 min prior to inoculation.

The inoculum was prepared by making a 1:1 pool of overnight cultures of 6 different Gram negative and Gram positive bacterial strains, and then diluted 1:20 with tryptic soy broth. The bacterial suspension (6 μL) was added to preserved RM-2020E solutions (600 μL). The sample block was then sealed using a rubber mat and vortexed on a MixMate for 10 min. The assay block was placed in a sealed container and stored at 30° C. Three additional challenges were performed 7 d apart with fresh bacterial cultures and growth recovery was assessed 1 and 7 d after inoculation.

Ratings were performed on the TAUNOVATE℠ III High Throughput testing system by adding 20 μL of each inoculated sample into plates containing 180 μL of tryptic soy broth

(TSB) with indicator. The plates were serially diluted 10-fold to calculate the most probable number (MPN) of bacteria in each sample. Plates were stored at 30° C. for 48 h. The MPN was calculated to determine the relative growth scale rating, which is a measure of the passing or failure of the sample for growth.

Table 1 illustrates a number of environmentally acceptable biocides that were tested for heat age stability and efficacy against microbial growth. Environmentally acceptable biocides have a boiling point above 250° C. (that is, they are not VOCs) and are not known to be skin sensitizers,

If the biocide did not pass the heat age stability test, it was deemed not relevant for testing efficacy. All heat aged samples were compared against a reference HEUR (RM-2020E or

RM-8W) that contained Kathon LX biocide, which passed heat age testing (no change in appearance from sample prior to heat age testing) as well as efficacy testing but which is considered a sensitizer. Some samples discolored even prior to heat age testing but were heat age tested anyway; none of these samples were further tested for efficacy. The pass/fail criterion for biocide efficacy was determined by the formation of less than 1×10⁴ colony forming units per mL (CFU/mL) of sample tested.

TABLE 1
Heat Age stability and Efficacy of HEUR-Biocide Formulation

| | Sample | |
|---|---|---|
| Biocide(s) added to HEUR | Appearance after | Challenge |
| (biocide conc.) | Heat Age testing | Test |
| Sodium pyrithione | Bright yellow | Not relevant |
| Zinc pyrithione | White sediment | Not relevant |
| Zinc pyrithione + potassium | Yellow sediment | Not relevant |
| sorbate | | |
| Sodium o-phenylphenolate | White | Not relevant |
| | sediment/snowflakes | |
| o-phenylphenol | White | Not relevant |
| | sediment/snowflakes | |
| Silver, Silver nitrate | Fluffy tan sediment | Not relevant |
| Potassium sorbate | Brown | Not relevant |
| Potassium sorbate (1800-18,000 | unchanged | Fail |
| ppm) + phenoxyethanol (1800- | | |
| 18,000 ppm) | | |
| Dodecylguanidine Hydrochloride | unchanged | Fail |
| (300 ppm) | | |
| Didecyldimethylammonium chloride | unchanged | Fail |
| (400 ppm) | | |
| 1-bromo-3-chloro-5,5- | unchanged | Pass |
| dimethylhydantoin (15-40 ppm) | | |

Table 1 shows that 7 of the 12 biocides did not pass heat age testing and were therefore rejected for consideration for that reason. Of the remaining 5 that passed heat age studies, only 1-bromo-3-chloro-5,5-dimethylhydantoin, passed the challenge test.

1. A composition comprising water, and, based on the weight of the composition a) from 5 to 50 weight percent of a rheology modifier; and b) from 1 ppm to 1500 ppm 1-bromo-3-chloro-5,5-dimethylhydantoin.

2. The composition of claim 1 wherein the rheology modifier is a hydrophobically modified alkylene oxide urethane copolymer, an alkali swellable emulsion, a hydrophobically modified alkali swellable emulsion, or a hydrophobically modified hydroxyethyl cellulose.

3. The composition of claim 2 wherein the rheology modifier is a hydrophobically modified alkylene oxide urethane copolymer, which is a hydrophobically modified ethylene oxide urethane copolymer.

4. The composition of claim 3 which comprises from 10 to 35 weight percent of the hydrophobically modified ethylene oxide urethane copolymer based on the weight of the composition.

5. The composition of claim 4 which comprises from 5 ppm to 500 ppm of 1-bromo-3-chloro-5,5-dimethylhydantoin based on the weight of the composition.

6. The composition of claim 4 which comprises from 5 ppm to 100 ppm of 1-bromo-3-chloro-5,5-dimethylhydantoin based on the weight of the composition.
